(19) United States
(12) Patent Application Publication
(10) Pub. No.: US 2019/0012755 A1
(43) Pub. Date: Jan. 10, 2019

(54) MULTI-DRIVER, MULTI-LAW ENFORCEMENT OFFICER TRACKING, MAPPING, MATCHING, AND COMMUNICATION SYSTEM FOR TRAFFIC STOPS USING ENCRYPTED VOLUNTEERED DRIVER INFORMATION

(71) Applicants: Benjamin Williams, Sugarland, TX (US); Pandora Williams, Sugarland, TX (US)

(72) Inventors: Benjamin Williams, Sugarland, TX (US); Pandora Williams, Sugarland, TX (US)

(21) Appl. No.: 16/028,698

(22) Filed: Jul. 6, 2018

Related U.S. Application Data
(60) Provisional application No. 62/530,711, filed on Jul. 10, 2017.

(51) Int. Cl. G06Q 50/26; H04L 29/06; G06F 21/60

(52) U.S. Cl. CPC G06Q 50/26; G06F 21/606; H04L 63/08

(57) ABSTRACT

A multi-driver, multi-law enforcement officer tracking, mapping, matching, and communication system for traffic stops uses encrypted volunteered driver information.

### CROSS REFERENCE TO RELATED APPLICATIONS

The present application claims priority to and the benefit of co-pending U.S. Provisional Patent Application Ser. No. 62/530,711 filed on Jul. 10, 2017, entitled “MULTI-DRIVER, MULTI-POLICEMAN TRACKING, MAPPING, AND MATCHING SYSTEM FOR TRAFFIC STOPS USING ENCRYPTED VOLUNTEERED DRIVER INFORMATION” (our reference 3031.001). This reference is hereby incorporated in its entirety.

### FIELD

The present embodiment generally relates to a system for making traffic stops safer for drivers and law enforcement officers by providing encrypted volunteered information on the driver to a law enforcement officer in advance of approaching a vehicle during a traffic stop.

### BACKGROUND

A need exists for making traffic stops safer for law enforcement officers and motorists.

A further need exists for use of GPS technology to assist in one of the most dangerous activities in policing.

A need exists to gain more insight about a driver before the law enforcement officer approaches a vehicle at a traffic stop.

A need exists to improve the confidence of a motorist that the law enforcement officer is not a person impersonating a law enforcement officer.

The present embodiments meet these needs.

### BRIEF DESCRIPTION OF THE DRAWINGS

The detailed description will be better understood in conjunction with the accompanying drawings as follows:

FIG. 1 depicts a multi-driver, multi-law enforcement officer tracking, mapping, matching, and communication system according to one or more embodiments.

FIGS. 2A-2D depict the memory according to one or more embodiments.

FIG. 3A-3B depicts a driver mobile device according to one or more embodiments.

FIG. 4 depicts a law enforcement officer mobile device according to one or more embodiments.

FIG. 5A-5B depicts volunteered driver information according to one or more embodiments.

FIG. 6 depicts a map created by the system depicting the driver global positioning system (GPS) location and a plurality of law enforcement officer global positioning system (GPS) locations and depicting the law enforcement officer global positioning system (GPS) location closest to the driver global positioning system (GPS) location within a preset radius.

The present embodiments are detailed below with reference to the listed Figures.

### SUMMARY OF THE INVENTION

The multi-driver, multi-law enforcement officer tracking, mapping, matching, and communication system for traffic stops using encrypted volunteered driver information uses a driver mobile device, such as a cell phone, a server connected to a network which communicates with the driver cell phone, wherein the server has a processor, memory and a global positioning system mapping module in the memory.

The memory stores a plurality of instructions, which when executed by the processor, enable the processor to: (i) store a plurality of law enforcement officer mobile client device identification numbers, each law enforcement officer mobile client device configured to transmit a law enforcement officer GPS location to the processor, (ii) store law enforcement officer identification information for each law enforcement officer mobile client device; (iii) store a driver's mobile phone number configured to transmit a driver global positioning system (GPS) location to the processor for a driver; (iv) encrypt volunteered driver information forming encrypted volunteer driver information from the driver with the code, the volunteered driver information consisting of: driver name; driver birthdate; driver mobile phone number; driver special considerations; driver biography/occupation; driver's license number; driver's license issuing state; image of the driver's license; image of driver's concealed handgun license; and image of driver's insurance card.

The memory is configured to receive a driver global positioning system (GPS) location using the GPS mapping module for a driver pulled over for a traffic violation, wherein the driver has transmitted an “I'm being pulled over request” to the processor, and then position the driver global positioning system (GPS) location on a map using a global positioning system (GPS) coordinate transmitted by the driver's mobile device.

The processor is configured to receive a plurality of law enforcement officer global positioning system (GPS) locations from law enforcement officer mobile client devices within a preset radius of the driver's global positioning system (GPS) location using the global positioning system (GPS) mapping module and positions the plurality of law enforcement officer global positioning system (GPS) locations within the preset radius on the map and store them in the memory.

The memory instructs the processor to calculate distances from each of the law enforcement officer global positioning system (GPS) locations to the driver global positioning system (GPS) location; and identify the law enforcement officer global positioning system (GPS) location geographically closest to the driver global positioning system (GPS) location within the preset radius and identifies a law enforcement officer using law enforcement officer identification information with the matching law enforcement officer GPS location.

Once identified, the processor transmits the law enforcement officer law enforcement officer identification information to the driver's mobile device authenticating the law enforcement officer to the driver as a certified and verified law enforcement officer and not law enforcement officer impersonator.

Simultaneously, the driver mobile device memory instructs the driver mobile drive processor to use the law enforcement officer's law enforcement officer identification information, to transmit as a secure communication for a limited time period, a cryptographic nonce decryption key using the driver mobile device identification to the law enforcement officer's mobile device without revealing the law enforcement officer's mobile client device to the driver.

The memory stores additional instructions, which when executed by the processor, enable the processor to transmits encrypted volunteered driver information on the driver pulled over for a traffic violation to the law enforcement officer's mobile device.

Additionally, the law enforcement officer's mobile device uses the limited time period cryptographic nonce decryption key to decrypt the encrypted volunteered driver information enabling the law enforcement officer to perform traffic stop duties with improved safety using the volunteered driver information and the driver has improved personal safety knowing the law enforcement officer of the traffic stop is not a law enforcement officer impersonator and that the law enforcement officer already knows volunteered driver information on the driver.

The invention relates to a multi-driver, multi-law enforcement officer tracking, mapping, matching, and communication system using encrypted volunteered driver information, driver mobile devices, law enforcement officer mobile devices, processor, memory, global positioning system (GPS) mapping module with maps.

The system includes in the memory, instructions that enable the processor to: store law enforcement officer identification and encrypted volunteered driver information, map law enforcement officer GPS location to a driver GPS location when the driver has transmitted a prewritten alert.

The processor calculates distances from law enforcement officer to driver to identify law enforcement officer with the closest distance to the driver within a preset radius using a mapping module while simultaneously identifying the law enforcement officer to the driver using law enforcement officer identification information.

The processor transmits a cryptographic nonce decryption key to the law enforcement officer mobile device to decrypt encrypted volunteered driver information enabling law enforcement officer to perform traffic stops with safety using the decrypted volunteered driver information.

Additionally, the driver has improved personal safety knowing the law enforcement officer is not a law enforcement officer impersonator and that the law enforcement officer already knows decrypted volunteered driver information.

Before explaining the present apparatus in detail, it is to be understood that the apparatus is not limited to the particular embodiments and that it can be practiced or carried out in various ways.

Problems have existed with people impersonating policemen pulling over women and assaulting them.

On Jun. 9, 2017 news channel ABC13.com reported a man dressed as a law enforcement officer pulled over a woman and sexually assaulted her at 9900 Sugar Branch on Apr. 17, 2017. The 27 year old woman said she was driving when a man in a dark blue uniform stopped her for a traffic violation at 3 am. He handcuffed her and put in the back of his black Crown Victoria that had emergency equipment. The man then drove the victim to an unknown location and sexually assaulted her, according to investigators. The man is at large and a reward has been offered for his arrest.

A need exists for a system using mobile phones and GPS locators to stop law enforcement officer impersonators and stop sexual assault.

The goal of the system is to use technology including smart phone technology and GPS technology to make traffic stops safer.

The invention allows drivers to send key, volunteered information, to officers as soon as the driver is pulled over by a law enforcement officer.

The invention enables a driver to send their personal information to the law enforcement officer before the law enforcement officer gets out of the vehicle.

As part of normal protocol, law enforcement officer run plates, but the law enforcement officers do not know who is actually driving the vehicle.

This invention enables both driver and law enforcement officer to have a level of comfort on with whom each party is interacting. For law enforcement officers, this invention provides more insight into who is driving the vehicle including personal information about the driver, like phone number, driver email, driver name, driver date of birth, driver's license, driver's license issuing state, driver's insurance policy, driver's concealed handgun license, driver's personal biography/occupation, and special considerations concerning the driver, like partial blindness, or need for glasses, or a need for sign language or lip reading, bi-polar disorder, or post-traumatic stress disorder.

The following terms and phrases are used herein:

The phrase “closest to the driver GPS location” refers to a direct route regardless of terrain or street limitations, or could be by drivable route, depending on a user selection.

The term “global positioning system” herein GPS can refer to global navigation satellite system that provides geolocation and time information to a GPS receiver anywhere on or near the Earth where there is an unobstructed line of sight to four or more GPS satellites.

The term “law enforcement officer” as used herein includes but is not limited to a sheriff, a state trooper, an undercover officer, a patrol officer, a military law enforcement officer, airport policemen, metro police, campus police on colleges and universities.

The term “network” as used herein refers to a cellular network, a satellite network, a global positioning network, a global communication network, a local area network, a wide area network, Wi-Fi, and combinations thereof.

The term “memory” as used herein can refer to a non-transitory computer readable medium, such as a hard disk drive, solid state drive, flash drive, tape drive, and the like. The term “non-transitory computer readable medium” excludes any transitory signals but includes any non-transitory data storage circuitry, e.g., buffers, cache, and queues, within transceivers of transitory signals. The administrative data storage can contain various computer instructions to instruct the administrative processor to perform various tasks.

The term “nonce” as used herein refers to an arbitrary number used only once in a cryptographic communication, in the spirit of a nonce word. They are often random or pseudo-random numbers.

The term “special considerations” as used herein refers to mental/physical health issues/disabilities that could impact the driver's ability to interact with a law enforcement officer, as for instance a hearing loss, PTSD, or bi-polar disorder.

In brief the invention operates as follows: a driver is pulled over by a law enforcement officer.

The driver presses an “I'm being pulled over” button on the application on the driver's phone.

A custom formula calculates the nearest law enforcement officer to the driver using GPS signals from nearby law enforcement officer's mobile phones.

The driver receives a notification of an officer name and badge number of the closest geographic officer to his location.

The officer at the closest geographic location to the driver receives a packet of voluntary driver information about the driver prior to approaching the vehicle.

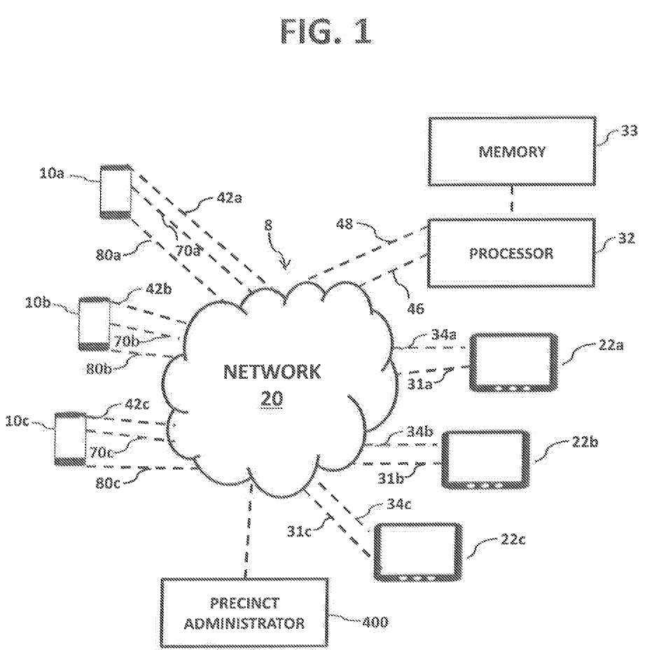

Turning now to the Figures, FIG. 1 depicts a multi-driver, multi-law enforcement officer tracking, mapping, matching, and communication system 8 for traffic stops using encrypted volunteered driver information.

The multi-driver, multi-law enforcement officer tracking, mapping, matching, and communication system 8 can have a plurality of driver mobile devices 10a-10c. Each driver mobile device 10a-10c is in communication with a network 20.

Each driver mobile device provides a driver global positioning system (GPS) location 42a-42c to a processor 32 which is additionally connected to the network 20.

An example of a driver mobile device can be a smart phone, a tablet, a smart watch, vehicle navigation system, or any other mobile computing device.

Additionally, each driver mobile device can transmit as a secure communication a limited time period cryptographic nonce decryption key shown as elements 80a to 80c.

Each of the limited time period cryptographic nonce decryption key transfer to one of the law enforcement officer mobile devices 22a-22c, which are connected to the network.

In embodiments, the cryptographic nonce decryption key is generated and has a time key operability of 1 minute. As an explanation, once the driver transmits prewritten message, “I'm being pulled over” a cryptographic nonce decryption key is generated by the processor and is available for use by a law enforcement officer for only 1 minute. During that short one minute period, the cryptographic nonce decryption key then decrypts encrypted volunteered information on the driver. The decrypted volunteered information on the driver can be available for viewing from 1 minute to 1 hour by the law enforcement officer.

The processor 32, which can be a computer, can be in communication with each driver mobile device 10a-10c and with each law enforcement officer mobile device 22a-22c through the network 20.

The processor 32 can store volunteered driver information 46 stored in a memory connected to the processor via the network, forming encrypted volunteer driver information 48 that is transmitted from the processor to the network.

In embodiments, the processor can receive the driver global positioning system (GPS) location a 42a-42c from each respective driver mobile device, 10a-10c and install the driver global positioning system locations 42a-42c onto a map in a global positioning system mapping module stored in memory connected to the processor.

The mapping occurs when each driver is pulled over for a traffic violation and after each driver activates and transmits a prewritten alert shown as elements 70a-70c from the driver mobile devices to the processor via the network.

In embodiments, the processor 32 can receive a plurality of law enforcement officer GPS locations 31a-31c transmitted from each of the law enforcement officer mobile devices 22a-22c within a preset radius of the driver's GPS location using the GPS mapping module and transmits from memory 33 the law enforcement officer identification information 34a-34c from memory to the driver mobile device via the network. The law enforcement officer identification information can include a prewritten message that indicates which law enforcement officer is “a cop on duty”.

In embodiments, a precinct administrator 400 can transmit law enforcement officer identification information 34a-c for a precinct to the memory 33 using the network 20.

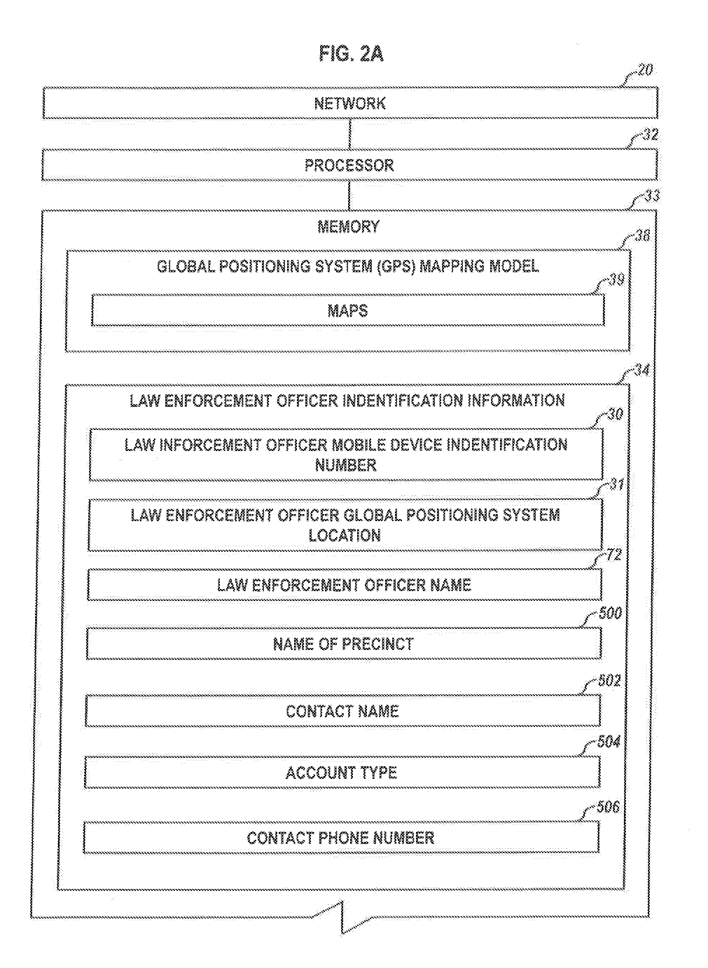

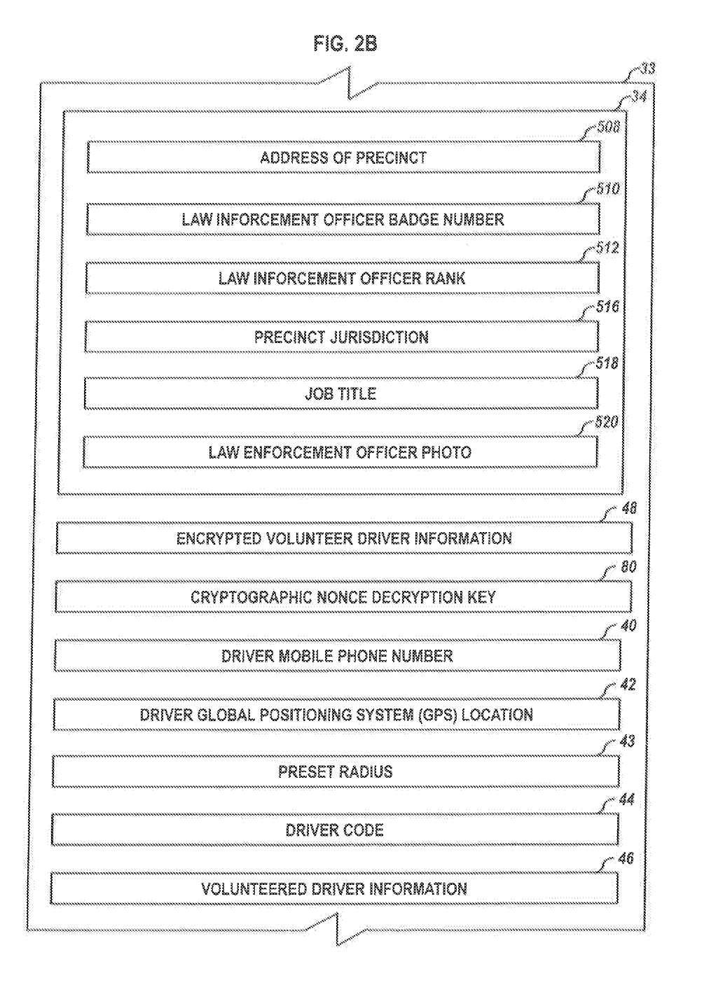

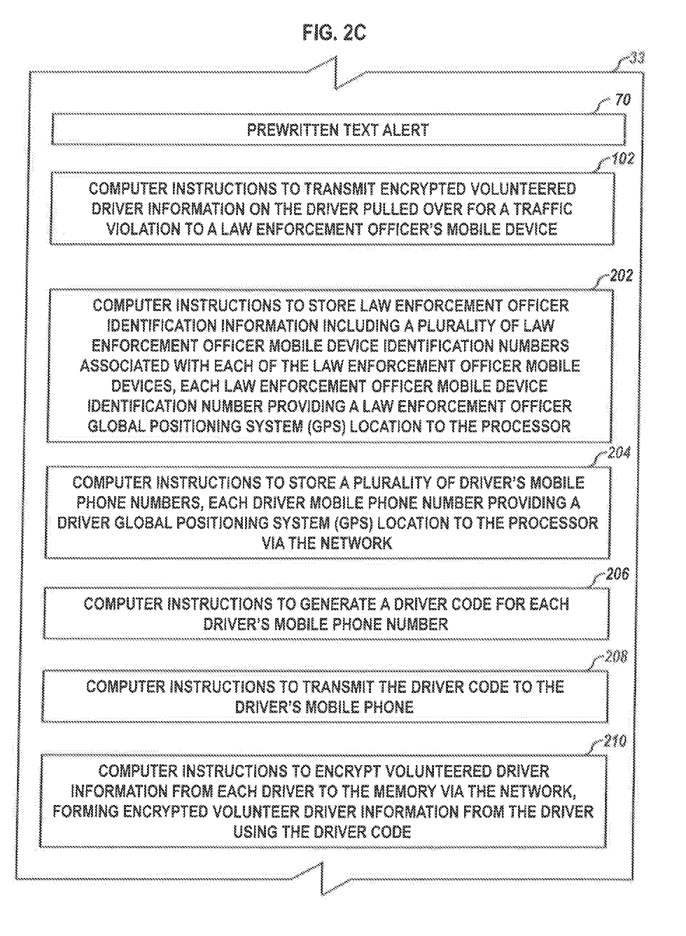

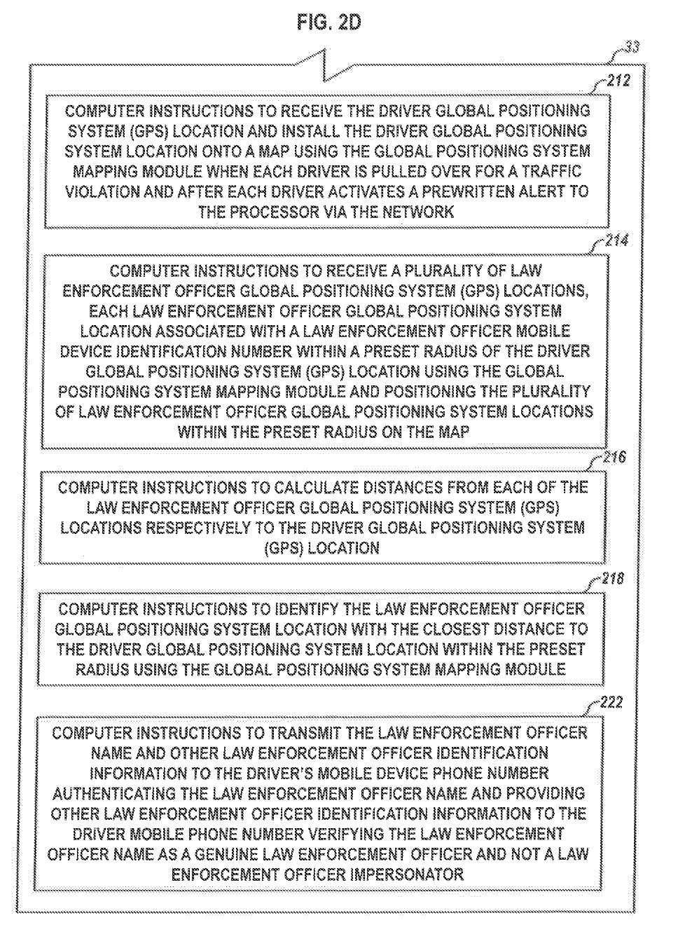

FIGS. 2A-2D depict the memory 33 according to one or more embodiments.

The memory 33 is non-transitory computer readable memory, and can be in communication with the processor 32 connected to a network 20.

The memory 33 can contain a global positioning system (GPS) mapping module 38 with a plurality of maps 39.

The memory 33 can contain law enforcement officer identification information 34 that includes: a law enforcement officer mobile device identification number 30, a law enforcement officer global positioning system (GPS) location 31, a law enforcement officer name 72, a name of a precinct 500, a contact name 502, an account type 504, a contact phone number 506, an address of a precinct 508, a law enforcement officer badge number 510, a law enforcement officer rank 512, a precinct jurisdiction 516, a job title 518, and a law enforcement officer's photo 520.

The memory includes encrypted volunteered driver information 48 and a cryptographic nonce decryption key 80.

In embodiments, the memory 33 can contain a driver mobile phone number 40, a driver global positioning system (GPS) location 42, a preset radius 43, a driver code 44, volunteered driver information 46, and a prewritten text alert 70.

For example, the prewritten text alert 70 can be “I'm being pulled over”.

The memory 33 can include computer instructions 102 to instruct the processor to transmit encrypted volunteered driver information on the driver pulled over for a traffic violation to a law enforcement officer's mobile device.

The memory can include computer instructions 202 to instruct the processor to store law enforcement officer identification information including a plurality of law enforcement officer mobile device identification numbers associated with each of the law enforcement officer mobile devices, each law enforcement officer mobile device identification number providing a law enforcement officer global positioning system (GPS) location to the processor.

The memory can include computer instructions 204 to instruct the processor to store a plurality of driver's mobile phone numbers, each driver mobile phone number providing a driver global positioning system (GPS) location to the processor via the network.

The memory can include computer instructions 206 to instruct the processor to generate a driver code 44 for each driver's mobile phone number.

The memory can include computer instructions 208 to instruct the processor to transmit the driver code 44 to the driver's mobile phone.

The memory can include computer instructions 210 to instruct the processor to encrypt volunteered driver information from each driver to the memory via the network, forming encrypted volunteer driver information from the driver using the driver code.

The encrypted volunteered driver information can consist of a driver name, a driver birthdate, a driver mobile phone number, a driver special considerations, a driver biography/occupation, a driver license number, a driver license issuing state, an image of driver's license, an image of driver's concealed handgun license, and an image of driver's insurance card 64, and a drivers preferred language 66.

The memory can include computer instructions 212 to instruct the processor to receive the driver global positioning system (GPS) location and install the driver global positioning system location onto a map using the global positioning system mapping module when each driver is pulled over for a traffic violation and after each driver activates a prewritten alert to the processor via the network.

The memory can include computer instructions 214 to instruct the processor to receive a plurality of law enforcement officer global positioning system (GPS) locations, each law enforcement officer global positioning system location associated with a law enforcement officer mobile device identification number within a preset radius of the driver global positioning system (GPS) location using the global positioning system mapping module and positioning the plurality of law enforcement officer global positioning system locations within the preset radius on the map.

The memory can include computer instructions 216 to instruct the processor to calculate distances from each of the law enforcement officer global positioning system (GPS) locations respectively to the driver global positioning system (GPS) location.

The memory can include computer instructions 218 to instruct the processor the processor to identify the law enforcement officer global positioning system location with the closest distance to the driver global positioning system location within the preset radius using the global positioning system mapping module.

The memory can include computer instructions 222 to instruct the processor the processor to transmit the law enforcement officer name and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

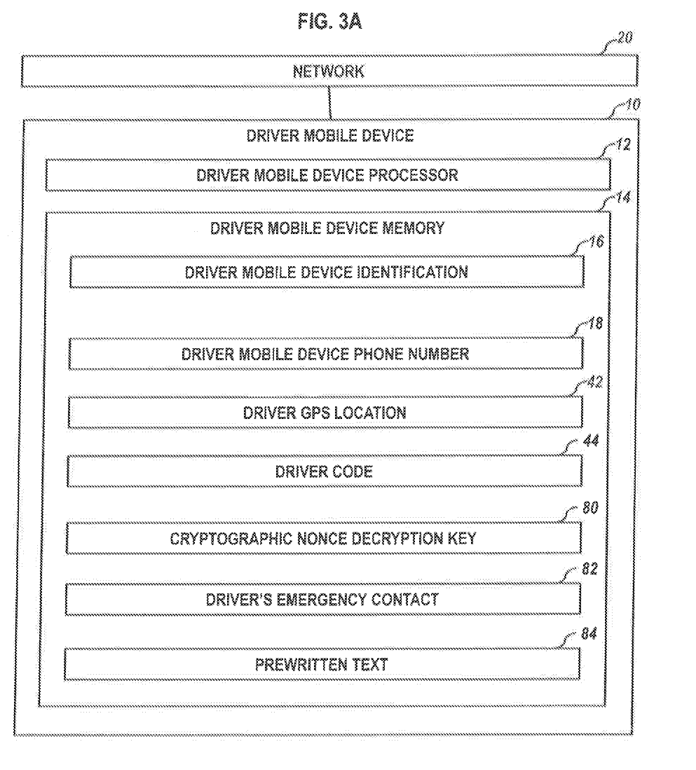

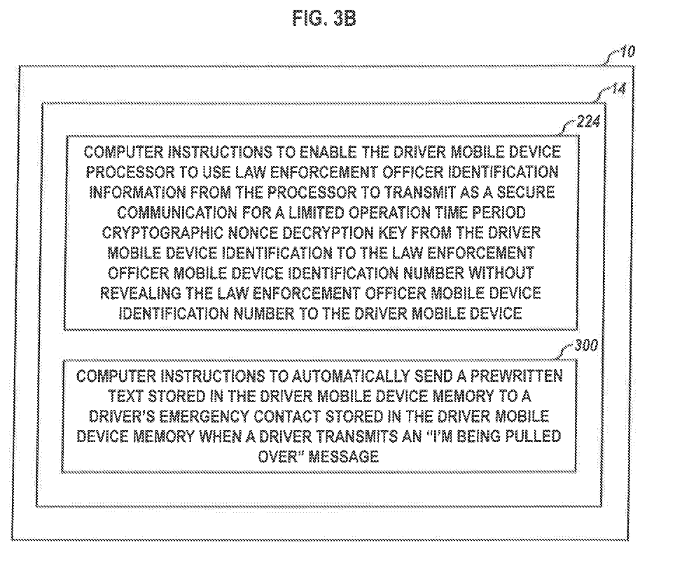

FIGS. 3A-3B depicts a driver mobile device 10 connected to a network 20 according to one or more embodiments.

The driver mobile device 10 has driver mobile device processor 12 in communication with a driver mobile device memory 14.

The driver mobile device memory 14 can have driver mobile device identification 16, a driver mobile device phone number 18, a driver GPS location 42, a driver code 44, a cryptographic nonce decryption key 80, a driver's emergency contact 82 and prewritten text 84.

The driver mobile device memory includes computer instructions 224 that when executed by the driver mobile device processor, enable the driver mobile device processor to use law enforcement officer identification information from the processor to transmit as a secure communication for a limited operation time period cryptographic nonce decryption key from the driver mobile device identification to the law enforcement officer mobile device identification number without revealing the law enforcement officer mobile device identification number to the driver mobile device.

The cryptographic nonce decryption key and decrypted volunteered driver information enables the law enforcement officer to perform traffic stop duties with improved safety using the volunteered driver information and the driver has improved personal safety knowing the law enforcement officer of the traffic stop is not a law enforcement officer impersonator and that the law enforcement officer already knows volunteered driver information on the driver.

In an embodiment the driver's mobile device processor implements computer instructions 300 in the driver's mobile device memory wherein the driver mobile device processor automatically sends a prewritten text stored in the driver mobile device memory 14 to a driver's emergency contact stored in the driver mobile device memory 14 when a driver transmits an “I'm being pulled over” message using the driver mobile device processor.

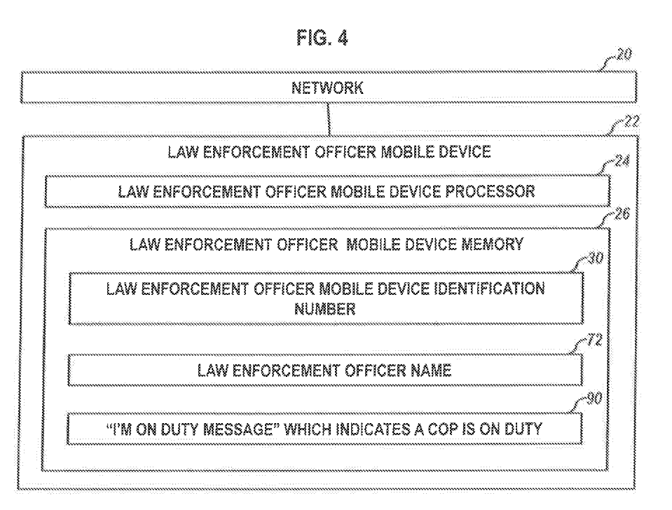

FIG. 4 depicts a law enforcement officer mobile device 22 connected to a network 20 according to one or more embodiments.

Each law enforcement officer mobile device 22 has a law enforcement officer mobile device processor 24 in communication with the network 20 and a law enforcement officer mobile device memory 26 containing law enforcement officer mobile device identification number 30, and law enforcement officer name 72.

In embodiments, the law enforcement officer mobile device memory can have message, which states “I'm on duty message” 90, which indicates a cop is on duty.

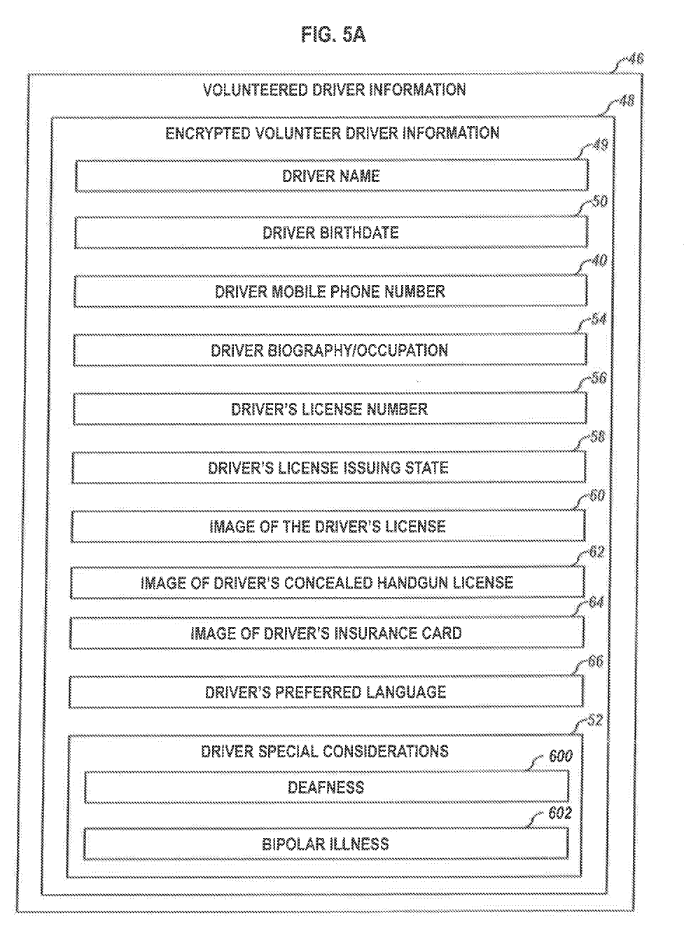

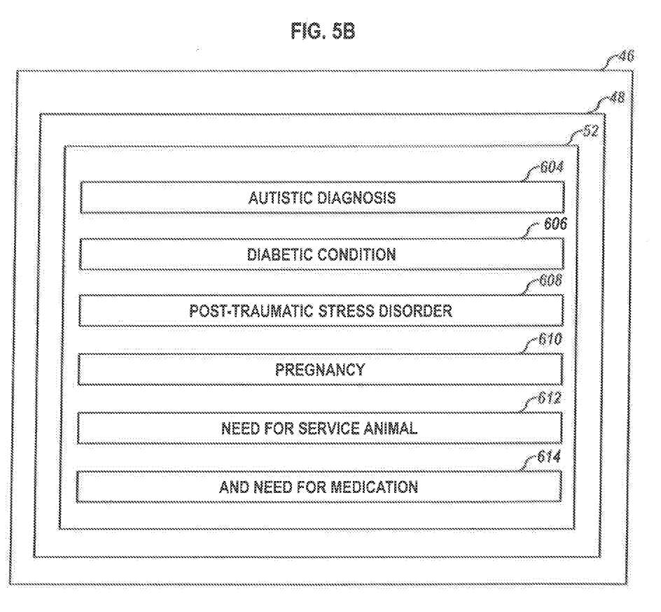

FIGS. 5A-5B depict volunteered driver information 46 according to one or more embodiments.

The volunteered driver information 46 becomes encrypted volunteer driver information which is then decrypted with the cryptographic nonce decryption key.

The encrypted volunteer driver information 48 includes a driver name 49, a driver birthdate 50, a driver mobile phone number 40, a driver special considerations 52; a driver biography/occupation 54, a driver's license number 56, a driver's license issuing state 58, an image of the driver's license 60, an image of driver's concealed handgun license 62, and an image of driver's insurance card 64, and driver's preferred language 66.

The driver special considerations 52 can be at least one of: deafness 600, bipolar illness 602, autistic diagnosis 604, diabetic condition 606, post-traumatic stress disorder 608, pregnancy 610, need for service animal 612, and need for medication 614, and any other mental/physical health issues/disabilities that could impact the driver's ability to interact with a law enforcement officer.

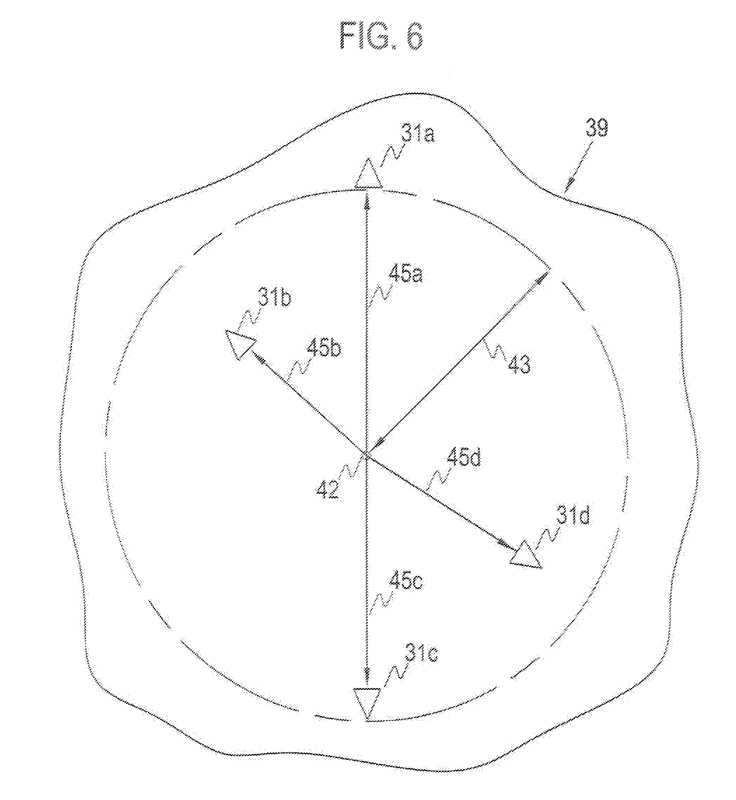

FIG. 6 depicts a map created by the system depicting the driver global positioning system (GPS) location and a plurality of law enforcement officer global positioning system (GPS) locations depicting the law enforcement officer global positioning system (GPS) location closest to the driver global positioning system (GPS) location.

The processor receives the driver global positioning system (GPS) location 42 and installs the driver global positioning system location onto a map 39 using the global positioning system mapping module stored in memory when each driver is pulled over for a traffic violation and after each driver activates a prewritten alert to the processor via the network.

The processor receives a plurality of law enforcement officer global positioning system (GPS) locations 31a-31d wherein each law enforcement officer global positioning system location is associated with a law enforcement officer mobile device identification number within a preset radius 43 of the driver global positioning system (GPS) location 42 using the global positioning system mapping module in memory and the processor positions the plurality of law enforcement officer global positioning system locations 31a-31d within the preset radius 43 on the map 39.

The processor calculates distances 45a-45d from each of the law enforcement officer global positioning system (GPS) locations 31a-31d respectively to the driver global positioning system (GPS) location 42.

The processor identifies the law enforcement officer global positioning system location with the closest distance to the driver global positioning system location 42 within the preset radius using the global positioning system mapping module, which is 45d on this FIG. 6.

The processor then identifies a law enforcement officer name 72 with the law enforcement officer GPS location 32 with the closest distance to the driver global positioning system location using the law enforcement officer identification information 34.

In embodiments, the volunteered driver information can be linked to social media from a button in the driver mobile device memory.

In embodiments, the multi-driver, multi-law enforcement officer tracking, mapping, and matching system for traffic stops using encrypted volunteered driver information can provide a preset message to mobile devices of emergency contacts of a driver at a traffic stop.

### EXAMPLE 1

A multi-driver, multi-law enforcement officer tracking, mapping, matching, and communication system for traffic stops using encrypted volunteered driver information has a plurality of driver mobile devices, such as a smart phone. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as a smart phone. Each law enforcement officer mobile device has a law enforcement officer mobile device processor and law enforcement officer mobile device memory and a law enforcement officer mobile device identification number. Each law enforcement officer mobile device is in communication with the network.

A processor is in communication with the driver's smart phone and each law enforcement officer's smart phone through the network.

A memory 33 is in communication with the processor.

A global positioning system (GPS) mapping module with a plurality of maps of the city of Houston in the global positioning system mapping module.

The memory stores a plurality of instructions, which when executed by the processor, enable the processor to store the Houston Police Department Officer's (HPD) law enforcement officer's identification information, including a plurality of law enforcement officer mobile device identification numbers associated with each of the law enforcement officer mobile devices, wherein each HPD officer's smart phone identification number provides a law enforcement global positioning system (GPS) location to the processor.

The memory also stores a plurality of driver's mobile phone numbers, such as 713-000-0000, wherein each driver mobile phone number provides a driver global positioning system (GPS) location to the processor via the network.

The memory stores encrypted volunteered driver information from the smart phone's memory via the network, forming encrypted volunteer driver information from the driver using the driver code, wherein the encrypted volunteered driver information consisting of: a driver name, such as Jeffrey Thomas; a driver birthdate, such as Jan. 1, 1980; a driver mobile phone number such as 713-000-0000; a driver special considerations, such as partially deafness from an injury sustained in the Afghanistan war and also suffering from PTSD; a driver biography/occupation, such as an middle school basketball coach; a driver license number, such as TX5555; a driver license issuing state, such as Texas; an image of driver's license; an image of driver's concealed handgun license; and an image of driver's insurance card.

The memory is able to receive the driver global positioning system (GPS) location, such as corner of Main Street and South Post Oak in Houston, Tex. and send the driver global positioning system location onto a map using the global positioning system mapping module when each driver is pulled over for a traffic violation and after each driver activates a prewritten alert to the processor via the network.

The memory calculate distances, such as 200 feet from each of the law enforcement officer global positioning system (GPS) locations respectively to the driver global positioning system (GPS) location.

The memory identifies a law enforcement officer name, such Officer Todd Smith, with the law enforcement officer GPS location with the closest distance to the driver global positioning system location, such as corner Main Street and South Post Oak in Houston, Tex., using the law enforcement officer identification information.

The memory transmits the law enforcement officer name, Todd Smith and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic notice decryption key to decrypt the encrypted volunteered driver information, enabling the law enforcement officer to perform, traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

### EXAMPLE 2

A multi-driver, multi-law enforcement officer tracking, mapping, matching, and communication system for traffic stops using encrypted volunteered driver information has a plurality of driver mobile devices, such as a smart phone. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as a tablet. Each law enforcement officer mobile device has a law enforcement mobile device processor and law enforcement mobile device memory and a law enforcement mobile device identification number. Each law enforcement officer mobile device is in communication with the network.

A processor is in communication with the driver's smart phone and each law enforcement officer's tablet through the network.

A memory 33 is in communication with the processor.

A global positioning system (GPS) mapping module with a plurality of maps of the University of Texas at Austin in the global positioning system mapping module.

The memory stores a plurality of instructions, which when executed by the processor, enable the processor to store the University of Texas at Austin Police Department Officer's (UTPD) law enforcement officer's identification information including a plurality of law enforcement officer mobile device identification numbers associated with each of the law enforcement officer mobile devices, wherein each UTPD officer's tablet's identification number provides a law enforcement global positioning system (GPS) location to the processor.

The memory stores a plurality of driver's mobile phone numbers, such as 512-111-1111, wherein each driver mobile phone number provides a driver global positioning system (GPS) location to the processor via the network.

The memory encrypts volunteered driver information from the smart phone's memory via the network, forming encrypted volunteer driver information from the driver using the driver code, wherein the encrypted volunteered driver information consisting of: a driver name, such as Lisa White; a driver birthdate, such as Mar. 1,1998; a driver mobile phone number such as 512-111-1111; a driver special considerations, such as Bi-Polar; a driver biography/occupation, such as biology student; a driver license number, such as TX2222; a driver license issuing state, such as Texas; an image of driver's license; an image of driver's concealed handgun license; and an image of driver's insurance card.

The memory receives the driver global positioning system (GPS) location, such as corner San Jacinto Blvd and E 24^{th} St and send the driver global positioning system location onto a map using the global positioning system mapping module when each driver is pulled over for a traffic violation and after each driver activates a prewritten alert to the processor via the network.

The memory calculates distances, such as 50 feet from each of the law enforcement officer global positioning system (GPS) locations respectively to the driver global positioning system (GPS) location.

The memory identifies a law enforcement officer name, such Officer Steve Lyles, with the law enforcement officer GPS location with the closest distance to the driver global positioning system location, such as corner San Jacinto Blvd and E 24^{th} St, using the law enforcement officer identification information.

The memory transmits the law enforcement officer name, Steve Lyles and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic nonce decryption key to decrypt the encrypted volunteered driver information, enabling the law enforcement officer to perform traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

The driver's mobile device sends a text to the driver's contacts, which are her parents. This provides a feeling of improved personal safety knowing that the driver parents are aware of that the driver has been stopped by a law enforcement officer.

### EXAMPLE 3

A multi-driver, multi-law enforcement officer tracking, mapping, matching, and communication system for traffic stops using encrypted volunteered driver information has a plurality of driver mobile devices, such as a smart phone. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as a smart phone. Each law enforcement officer mobile device has a law enforcement mobile device processor and law enforcement mobile device memory and a law enforcement mobile device identification number. Each law enforcement officer mobile device is in communication with the network.

A processor is in communication with the driver's smart phone and each law enforcement officer's smart phone through the network.

A memory 33 is in communication with the processor.

A global positioning astern (GPS) mapping module with a plurality of maps of the city of Sugar Land, Tex. in the global positioning system mapping module.

The memory stores a plurality of instructions, which when executed by the processor, enable the processor to store the Sugar Land Police Department Officer's (SLPD) law enforcement officer's identification information including a plurality of law enforcement officer mobile device identification numbers associated with each of the law enforcement officer mobile devices, wherein each SLPD officer's smart phone identification number provides a law enforcement global positioning system (GPS) location to the processor.

The memory stores a plurality of driver's mobile phone numbers, such as 281-222-2222, wherein each driver mobile phone number provides a driver global positioning system (GPS) location to the processor via the network.

The memory encrypts volunteered driver information from the smart phone's memory via the network, forming encrypted volunteer driver information from the driver using the driver code, wherein the encrypted volunteered driver information consisting of: a driver name, such as Cody Fields; a driver birthdate, such as Apr. 1, 1995; a driver mobile phone number such as 281-222-2222; a driver special considerations, such as diabetic condition; a driver biography/occupation, such as cell phone technician; a driver license number, such as TX1234; a driver license issuing state, such as Texas; an image of driver's license; an image of driver's concealed handgun license; and an image of driver's insurance card.

The memory receives the driver global positioning system (GPS) location, such as corner of Hwy 6 and Hwy 90 and send the driver global positioning system location onto a map using the global positioning system mapping module when each driver is pulled over for a traffic violation and after each driver activates a prewritten alert to the processor via the network.

The memory calculates distances, such as 1000 feet from each of the law enforcement officer global positioning system (GPS) locations respectively to the driver global positioning system (GPS) location.

The memory identifies a law enforcement officer name, such Officer Cedric Johns, with the law enforcement officer GPS location with the closest distance to the driver global positioning system location, such as corner of Hwy 6 and Hwy 90, using the law enforcement officer identification information.

The memory transmits the law enforcement officer name, Cedric Johns and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic nonce decryption key to decrypt the encrypted volunteered driver information, enabling the law enforcement officer to perform traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

### EXAMPLE 4

A multi-driver, multi-law enforcement officer tracking, mapping, matching, and communication system for traffic stops using encrypted volunteered driver information has a plurality of driver mobile devices, such as a smart phone. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as smart phone. Each law enforcement officer mobile device has a law enforcement mobile device processor and law enforcement mobile device memory and a law enforcement mobile device identification number. Each law enforcement officer mobile device is in communication with the network.

A processor is in communication with the driver's smart phone and each law enforcement officer's smart phone through the network.

A memory 33 is in communication with the processor.

A global positioning system (GPS) mapping module with a plurality of maps of the city of Baltimore, Md. in the global positioning system mapping module.

The memory stores a plurality of instructions, which when executed by the processor, enable the processor to store the Baltimore Police Department Officer's (BPD) law enforcement officer's identification information including a plurality of law enforcement officer mobile device identification numbers associated with each of the law enforcement officer mobile devices, wherein each BPD officer's smart phone's identification number provides a law enforcement global positioning system (GPS) location to the processor.

The memory stores a plurality of driver's mobile phone numbers, such as 410-333-3333, wherein each driver mobile phone number provides a driver global positioning system (GPS) location to the processor via the network.

The memory encrypts volunteered driver information from the smart phone's memory via the network, forming encrypted volunteer driver information from the driver using the driver code, wherein the encrypted volunteered driver information consisting of: a driver name, such as Thomas Schultz; a driver birthdate, such as Jan. 1, 1985; a driver mobile phone number such as 410-333-3333; a driver special considerations, such as bi-polar; a driver biography/occupation, such as computer hardware specialist; a driver license number, such as MD12345; a driver license issuing state, such as Maryland; an image of driver's license; an image of driver's concealed handgun license; and an image of driver's insurance card.

The memory receives the driver global positioning system (GPS) location, such as corner of W Pratt St, and S Sharp St. and send the driver global positioning system location onto a map using the global positioning system mapping module when each driver is pulled over for a traffic violation and after each driver activates a prewritten alert to the processor via the network.

The memory calculate distances, such as 0.25 mile from each of the law enforcement officer global positioning system (GPS) locations respectively to the driver global positioning system (GPS) location.

The memory identifies a law enforcement officer name, such Officer Tina Gordon, with the law enforcement officer GPS location with the closest distance to the driver global positioning system location, such as corner W Pratt St. and S Sharp St., using the law enforcement officer identification information.

The memory transmits the law enforcement officer name, Tina Gordon and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic nonce decryption key to decrypt the encrypted volunteered driver information, enabling the law enforcement officer to perform traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

### EXAMPLE 5

A multi-driver, multi-law enforcement officer tracking, mapping, matching, and communication system for traffic stops using encrypted volunteered driver information has a plurality of driver mobile devices, such as a tablet. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as tablet. Each law enforcement officer mobile device has a law enforcement mobile device processor and law enforcement mobile device memory and a law enforcement mobile device identification number. Each law enforcement officer mobile device is in communication with the network.

A processor is in communication with the driver's tablet and each law enforcement officer's tablet through the network.

A memory 33 is in communication with the processor.

A global positioning system (GPS) mapping module with a plurality of maps of the city of New York in the global positioning system mapping module.

The memory stores a plurality of instructions, which when executed by the processor, enable the processor to store the New York Police Department Officer's (N YPD) law enforcement officer's identification information including a plurality of law enforcement officer mobile device identification numbers associated with each of the law enforcement officer mobile devices, wherein each NYPD officer's tablet's identification number provides a law enforcement global positioning system (GPS) location to the processor.

The memory stores a plurality of driver's mobile phone numbers, such as 212-111-0000, wherein each driver mobile phone number provides a driver global positioning system (GPS) location to the processor via the network.

The memory encrypts volunteered driver information from the tablet's memory via the network, forming encrypted volunteer driver information from the driver using the driver code, wherein the encrypted volunteered driver information consisting of: a driver name, such as: Jay Foster; a driver birthdate, such as Jan. 1, 1970; a driver mobile phone number such as 212-111-0000; a driver special considerations, such as taking medication; a driver biography/occupation, such as High School Teacher; a driver license number, such as NY12345; a driver license issuing state, such as New York; an image of driver's license; an image of driver's concealed handgun license; and an image of driver's insurance card.

The memory receives the driver global positioning system (GPS) location, such as corner of West Houston St. and Thompson St. and send the driver global positioning system location onto a map using the global positioning system mapping module when each driver is pulled over for a traffic violation and after each driver activates a prewritten alert to the processor via the network.

The memory calculates distances, such as 500 feet from each of the law enforcement officer global positioning system (GPS) locations respectively to the driver global positioning system (GPS) location.

The memory identifies a law enforcement officer name, such Officer Bill Littleton, with the law enforcement officer (GPS) location with the closest distance to the driver global positioning system location, such as corner West Houston St. and Thompson St., using the law enforcement officer identification information.

The memory transmits the law enforcement officer name, Bill Littleton and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic nonce decryption key to decrypt the encrypted volunteered driver information, enabling the law enforcement officer to perform traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

### EXAMPLE 6

A multi-driver, multi-law enforcement officer tracking, mapping, matching, and communication system for traffic stops using encrypted volunteered driver information has a plurality of driver mobile devices, such as a vehicle console device. Each driver mobile device has a driver mobile device processor, a driver mobile device memory with driver mobile device identification and driver mobile device phone number. Each driver mobile device is in communication with a network.

The multi-driver, multi-law enforcement officer tracking, mapping, matching, and communication system has a plurality of law enforcement officer mobile devices, such as a smart phone. Each law enforcement officer mobile device has a law enforcement mobile device processor and law enforcement mobile device memory and a law enforcement mobile device identification number. Each law enforcement officer mobile device is in communication with the network.

A processor is in communication with the driver's vehicle console and each law enforcement officer's smart phone through the network.

A memory 33 is in communication with the processor.

A global positioning system (GPS) mapping module with a plurality of maps of the city of Los Angeles in the global positioning system mapping module.

The memory stores a plurality of instructions, which when executed by the processor, enable the processor to store the Los Angeles Police Department Officer's (LAPD) law enforcement officer's identification information including a plurality of law enforcement officer mobile device identification numbers associated with each of the law enforcement officer mobile devices, wherein each LAPD officer's smart phone identification number provides a law enforcement global positioning system (GPS) location to the processor.

The memory stores a plurality of driver's mobile phone numbers, such as 424-555-5555, wherein each driver mobile phone number provides a driver global positioning system (GPS) location to the processor via the network.

The memory encrypts volunteered driver information from the vehicle console memory via the network, forming encrypted volunteer driver information from the driver using the driver code, wherein the encrypted volunteered driver information consisting of: a driver name, such as Denise Jones; a driver birthdate, such as Jun. 1, 1992; a driver mobile phone number such as 424-555-5555; a driver special considerations, such as pregnant; a driver biography/occupation, such as home maker; a driver license number, such as CA12345; a driver license issuing, state, such as California; an image of driver's license; an image of driver's concealed handgun license; and an image of driver's insurance card.

The memory receives the driver global positioning system (GPS) location, such as corner Venice Blvd and Hauser Blvd and send the driver global positioning system location onto a map using the global positioning system mapping module when each driver is pulled over for a traffic violation and after each driver activates a prewritten alert to the processor via the network.

The memory calculates distances, such as 500 feet from each of the law enforcement officer global positioning system (GPS) locations respectively to the driver global positioning system (GPS) location.

The memory identifies a law enforcement officer name, such Officer Ted Jackson, with the law enforcement officer GPS location with the closest distance to the driver global positioning system location, such as corner Venice Blvd and Hauser Blvd, using the law enforcement officer identification information.

The memory transmit the law enforcement officer name, Ted Jackson and other law enforcement officer identification information to the driver's mobile device phone number thus authenticating the law enforcement officer name and providing other law enforcement officer identification information to the driver mobile phone number verifying the law enforcement officer name as a genuine law enforcement officer and not a law enforcement officer impersonator.

The driver mobile device memory stores a plurality of instructions, which when executed by the driver mobile device processor, enable the driver mobile drive processor to use the law enforcement officer identification information to transmit as a secure communication for a limited time period with a limited operation time, such as a 1 minute cryptographic nonce decryption key using the driver mobile device identification to the law enforcement officer mobile device identification number without revealing the law enforcement officer mobile device identification number to the driver mobile device.

The memory stores additional instructions, which when executed by the processor, enable the processor to transmit encrypted volunteered driver information on the driver pulled over for a traffic violation to the law enforcement officer's mobile device.

The law enforcement officer's mobile device uses the limited time period cryptographic nonce decryption key to decrypt the encrypted volunteered driver information, enabling the law enforcement officer to perform traffic stop duties with improved safety using the decrypted volunteered driver information. Also, the driver has improved personal safety knowing the law enforcement officer of the traffic stop is not a law enforcement impersonator and that the law enforcement officer already knows decrypted volunteered driver information.

While these embodiments have been described with emphasis on the embodiments, it should be understood that within the scope of the appended claims, the embodiments might be practiced other than as specifically described herein.

What is claimed is:

1. A multi-driver, multi-law enforcement officer tracking, mapping, matching, and communication system for traffic stops using encrypted volunteered driver information, comprising:
a. a plurality of driver mobile devices, each driver mobile device having a driver mobile device processor, a driver mobile device memory with driver mobile device identification and driver mobile device phone number, each driver mobile device in communication with a network;
b. a plurality of law enforcement officer mobile devices, each law enforcement officer mobile device having a law enforcement mobile device processor and law enforcement mobile device memory and a law enforcement mobile device identification number, each law enforcement officer mobile device in communication with the network;
c. a processor in communication with each driver mobile device and each law enforcement officer mobile device through the network;
d. a memory in communication with the processor;
e. a global positioning system (GPS) mapping module with a plurality of maps in the global positioning system mapping module;
wherein the memory stores a plurality of instructions to instruct the processor to:
(i) store law enforcement identification information including a plurality of law enforcement officer mobile device identification numbers associated with each of the law enforcement officer mobile devices, each law enforcement officer mobile device identification number providing a law enforcement global positioning system (GPS) location to the processor;
(ii) store a plurality of driver's mobile phone numbers, each driver mobile phone number providing a driver global positioning system (GPS) location to the processor via the network;
(iii) encrypt volunteered driver information from each driver to memory via the network, forming encrypted volunteered driver information from the driver using the driver code, the encrypted volunteered driver information consisting of: a driver name; a driver birthdate; a driver mobile phone number; a driver special considerations; a driver biography/occupation; a driver license number; a driver license issuing state; an image of driver's license; an image of driver's concealed handgun license; and an image of driver's insurance card;
(iv) receive the driver global positioning system (GPS) location and send the driver global positioning system location to a map using the global positioning system mapping module when each driver is pulled over for a traffic violation and after each driver activates a prewritten alert to the processor via the network;
(v) calculate distances from each of the law enforcement officer global positioning system (GPS) locations respectively to the driver global positioning system (GPS) location;
(vi) identify the law enforcement officer global positioning system location with the closest distance to the driver global positioning system location within the preset radius using the global positioning system mapping module;
(vii) transmit the law enforcement officer name and other law enforcement officer identification information to the driver's mobile device phone number authenticating the law enforcement officer name and providing other law enforcement officer identification information to the driver mobile phone number verifying the law enforcement officer name as a genuine law enforcement officer and not a law enforcement officer impersonator;
wherein the driver mobile device memory stores a plurality of instructions, which when executed by the driver mobile device processor, enable the driver mobile drive processor to use the law enforcement officer identification information to transmit as a secure communication for a limited time period with a limited operation time period cryptographic nonce decryption key using the driver mobile device identification to the law enforcement officer mobile device identification number without revealing the law enforcement officer mobile device identification number to the driver mobile device;
wherein the memory stores additional instructions, which when executed by the processor, enable the processor to transmit encrypted volunteered driver information on the driver pulled over for a traffic violation to the law enforcement officer's mobile device; and
wherein the law enforcement officer's mobile device uses the limited time period cryptographic nonce decryption key to decrypt the encrypted volunteered driver information; enabling the law enforcement officer to perform traffic stop duties with improved safety using the decrypted volunteered driver information and wherein the driver has improved personal safety knowing the law enforcement officer of the traffic stop is not a law enforcement impersonator and that the law enforcement officer already knows decrypted volunteered driver information.

2. The multi-driver, multi-law enforcement officer tracking, mapping, and matching system for traffic stops using encrypted volunteered driver information of claim 1, wherein the driver mobile device processor automatically sends a prewritten text stored in the driver mobile device memory to a driver's emergency contact stored in the driver mobile device memory when a driver transmits an “I'm being pulled over” message using the driver mobile device processor.

3. The multi-driver, multi-law enforcement officer tracking, mapping, and matching system for traffic stops using encrypted volunteered driver information of claim 1, wherein a precinct administrator installs law enforcement officer identification information for a precinct to the memory using the network.

4. The multi-driver, multi-law enforcement officer tracking, mapping, and matching system for traffic stops using encrypted volunteered driver information of claim, wherein the law enforcement officer identification information the memory that further comprises a name of precinct, a contact name, an account type, a contact phone number, and address of precinct.

5. The multi-driver, multi-law enforcement officer tracking, mapping, and matching system for traffic stops using encrypted volunteered driver information of claim 1, wherein the law enforcement officer identification information in the memory comprises at least one of: law enforcement officer name, name of precinct, law enforcement officer badge number, law enforcement officer rank, precinct jurisdiction, job title, and law enforcement officer's photo.

6. The multi-driver, multi-law enforcement officer tracking, mapping, and matching system for traffic stops using encrypted volunteered driver information of claim 1, wherein the processor receives the plurality of law enforcement officer GPS locations within a preset radius of the driver's GPS location using the GPS mapping module provide a preset “I'm on duty message” which indicate a cop is on duty.

7. The multi-driver, multi-law enforcement officer tracking, mapping, and matching system for traffic stops using encrypted volunteered driver information of claim 1, wherein driver special considerations comprise at least one of: deafness, bipolar illness, autistic diagnosis, diabetic condition, post-traumatic stress disorder; pregnancy, need for service animal, and need for medication.

8. The multi-driver, multi-law enforcement officer tracking, mapping, matching, and communication system for traffic stops using encrypted volunteered driver information of claim 1, wherein the limited time period for the cryptographic nonce decryption key operation is 1 minute.

9. The multi-driver, multi-law enforcement officer tracking, mapping, matching, and communication system for traffic stops using encrypted volunteered driver information of claim 1, wherein the memory stores instructions, which when executed by the processor, enable the processor to generate a driver code for each driver's mobile phone number.

10. The multi-driver, multi-law enforcement officer tracking, mapping, matching, and communication system for traffic stops using encrypted volunteered driver information of claim 1, wherein the memory stores instructions, which when executed by the processor, transmit the driver code to the driver's mobile phone.

11. The multi-driver, multi-law enforcement officer tracking, mapping, matching, and communication system for traffic stops using encrypted volunteered driver information of claim 1, wherein the memory stores instructions, which when executed by the processor, transmit the driver code to the driver's mobile phone.

12. The multi-driver, multi-law enforcement officer tracking, mapping, matching, and communication system for traffic stops using encrypted volunteered driver information of claim 1, wherein the memory stores instructions, which when executed by the processor, receive a plurality of law enforcement officer global positioning system (GPS) locations each law enforcement officer global positioning system location associated with a law enforcement officer mobile device identification number within a preset radius of the driver global positioning system (GPS) location using the global positioning system mapping module and positioning the plurality of law enforcement officer global positioning system locations within the preset radius on the map.
